(19) United States
(12) Patent Application Publication
(10) Pub. No.: US 2007/0236397 A1
(43) Pub. Date: Oct. 11, 2007

(54) Antenna device with antenna element coupled to anti-EMI plate of an electronic device

(76) Inventors: Yu-Chiang Cheng, Taipei City (TW); Ping-Cheng Chang, Chaozhou Town (TW); Cheng-Zing Chou, Xinying City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/651,981

(22) Filed: Jan. 11, 2007

(30) Foreign Application Priority Data
Apr. 7, 2006 (TW) 95112539

(51) Int. Cl. H01Q 1/24

(52) U.S. Cl. 343/702

(57) ABSTRACT

Disclosed is an antenna device arranged inside a display module of an electronic device with an anti-EMI plate. The antenna device includes an antenna element with a ground connecting end and a signal feeding end for transceiving a wireless signal, a ground connecting line coupled to the ground connecting end of the antenna element and the anti-EMI plate, and an antenna signal feeding line coupled to the signal feeding end of the antenna element for feeding the wireless signal transceived by the antenna element.

### FIELD OF THE INVENTION

The present invention relates to an antenna device used in wireless technology, and in particular to an antenna device with an antenna element coupled to an anti-EMI plate of an electronic device.

### BACKGROUND OF THE INVENTION

With the burgeoning of the wireless technologies nowadays, antenna devices for transceiving wireless signals have been widely utilized in electronic devices such as portable personal computers, cell phones, personal digital assistants and digital televisions capitalizing wireless transceiving. Hence the enhancement of the stability and the radiation efficiency of the antenna devices has become one of the most important aspects considering wireless technologies. The inventors, therefore, take a portable personal computer as an example to illustrate relative art.

With reference to the drawings and in particular to FIG. 1, which is an assembled perspective view of an electronic device provided with a conventional antenna device therein, the electronic device 100 includes a display module 1, a pivot mechanism 2 and a main body 3, wherein the display module 1 is integrated with the main body 3 by the pivot mechanism 2.

Please refer to FIG. 2 that is an exploded perspective view of FIG. 1. As shown in the figure, the display module 1 includes a display module casing 11, a display module screen 12 and an anti-EMI plate 13, wherein the anti-EMI plate 13 is a thin metal plate arranged on an inner surface of the display module casing 11 for protecting the display module 1 from possible electromagnetic interferences. The main body 3 includes a main body casing 31 and an antenna transceiving module 32, which is provided with an antenna signal feeding line connecting end 321 and an antenna transceiving module ground connecting end 322, wherein the antenna transceiving module 32 is arranged inside the main body casing 31.

An antenna element 4, which is electrically connected to the antenna module 32 by a coaxial cable 5, is also arranged at a predetermined position of the display module 1 for transceiving a wireless signal, wherein the coaxial cable 5 includes an antenna signal feeding line 51 and a ground connecting line 52.

With reference to FIG. 2 and FIG. 3, which is a perspective view of the connection of the antenna element 4 and the coaxial cable 5 with the antenna signal feeding line 51 and the ground connecting line 52, one end of the antenna signal feeding line 51 is connected to a signal feeding end 41 of the antenna element 4, while the other end of the antenna signal feeding line 51 is connected to the antenna signal feeding line connecting end 321. On the other hand, one end of the ground connecting line 52 is connected to a ground connecting end 42 of the antenna element 4, while the other end of the ground connecting line 52 is connected to the antenna transceiving module ground connecting end 322 of the antenna transceiving module 32.

### SUMMARY OF THE INVENTION

The antenna device of the electronic device of conventional use is coupled to the ground of the antenna transceiving module through the ground connecting line of the antenna element. Such ground is an analog ground and is not connected to the system ground. Since the area of the ground the antenna element connected to may have influence on the ability of the antenna element to prevent electromagnetic interferences, the relatively small ground of the antenna transceiving module may affect the prevention of the antenna element to electromagnetic interferences, and consequently affect the transceiving of the wireless signal of the antenna element.

In addition, since the length of the ground connecting line of conventional use is relatively longer, affections to the ability of the antenna element to prevent electromagnetic interferences is unavoidable.

The primary object of the present invention, therefore, is to provide an antenna device with an antenna element coupled to an anti-EMI plate in order to provide a ground with a larger area to the antenna element.

The other object of the present invention is to provide an antenna device with an antenna element coupled to an anti-EMI plate with a shorter ground connecting line.

To realize the above objects, the present invention installs an antenna element with a ground connecting end for transceiving a wireless signal, and a ground connecting line coupled to the ground connecting end of the antenna element and an anti-EMI plate of an electronic device. In a preferred embodiment of the present invention, the anti-EMI plate is a thin metal plate and arranged on an inner surface of a display module of the electronic device.

In comparison with the conventional technologies, the present invention provides the antenna element with a larger ground through the connecting of the antenna element to the anti-EMI plate of the electronic device through a shorter ground connecting line, hence enhances the stability and the quality of the transceiving of the wireless signal of the antenna element.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an electronic device provided with a conventional antenna device therein;

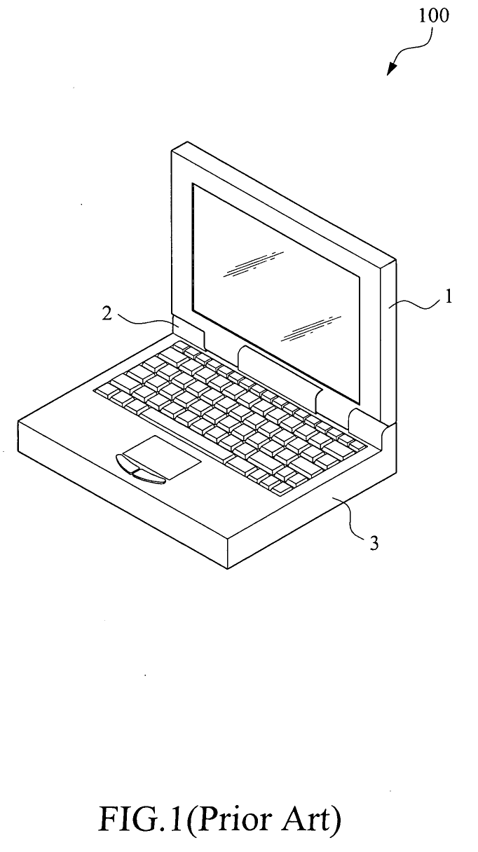

FIG. 2 is an exploded perspective view of FIG. 1;

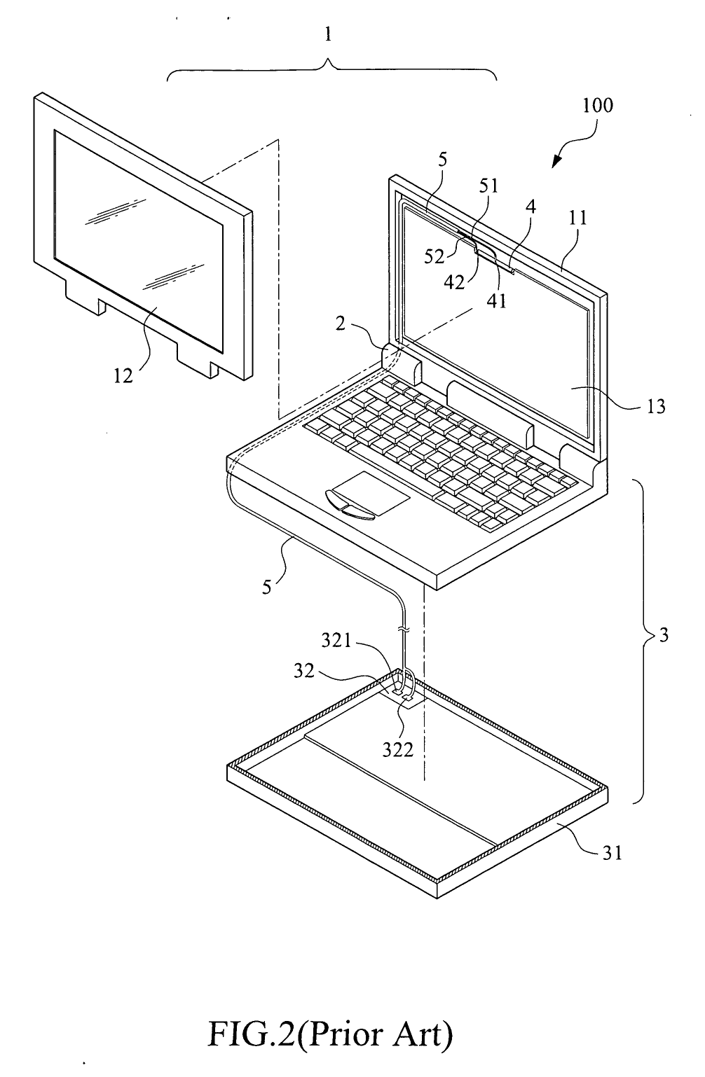

FIG. 3 is a perspective view of a connection of an antenna element and a coaxial cable with an antenna signal feeding line and a ground connecting line of conventional use;

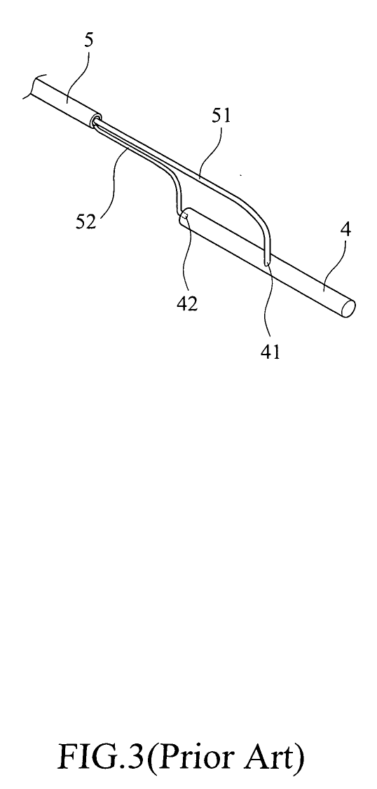

FIG. 4 is an exploded perspective view of an electronic device with an antenna element coupled to an anti-EMI plate in accordance with a preferred embodiment of the present invention; and

FIG. 5 is a perspective view of a connection of the antenna element, an antenna signal feeding line and a ground connecting line in accordance with the preferred embodiment of the present invention.

### DETAILED DESCRIPTION OF THE PREFERRED EMBODIMENTS

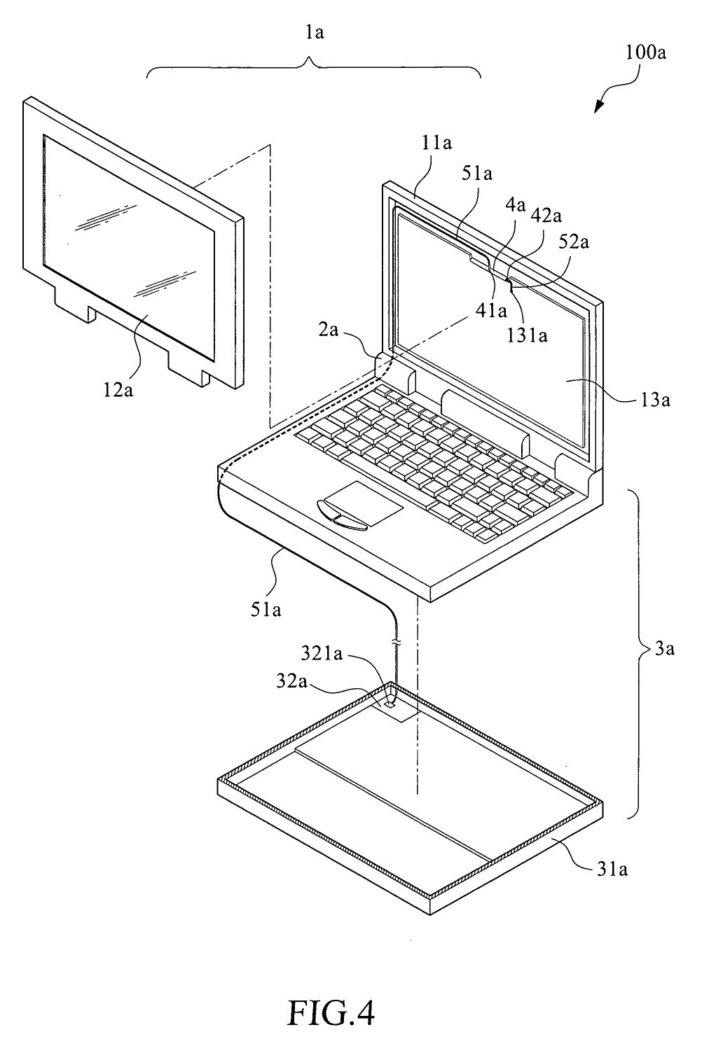

With reference to the drawing of FIG. 4, which is an exploded perspective view of an electronic device with an antenna element coupled to an anti-EMI plate in accordance with a preferred embodiment of the present invention, an electronic device 100a includes a display module 1a, a pivot mechanism 2a and a main body 3a, wherein the display module 1a is integrated with the main body 3a by the pivot mechanism 2a; hence the display module 1a is rotatably operable around the pivot mechanism 2a to cover the main body 3a or to be lift up.

As shown in the figure, the display module 1a includes a display module casing 11a, a display module screen 12a and an anti-EMI plate 13a, wherein the anti-EMI plate 13a includes an anti-EMI plate ground 131a. The main body 3a includes a main body casing 31a and an antenna transceiving module 32a, wherein the antenna transceiving module 32a is arranged inside the main body casing 31a. The antenna transceiving module 32a includes an antenna signal feeding line connecting end 321a.

Moreover, an antenna element 4a for transceiving a wireless signal is arranged at a predetermined position of the display module 1a. In the preferred embodiment of the present invention, the antenna element 4a is a dipole antenna and having a signal feeding end 41a and a ground connecting end 42a, and the antenna element 4a is coupled to an antenna signal feeding line 51a and a ground connecting line 52a.

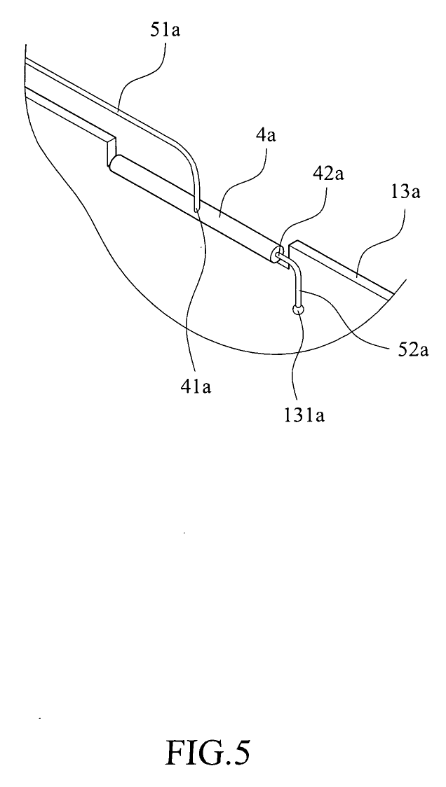

FIG. 5 is a perspective view of the connection of the antenna element 4a, the antenna signal feeding line 51a and the ground connecting line 52a in accordance with the preferred embodiment of the present invention. As shown in FIG. 4 and FIG. 5, one end of the antenna signal feeding line 51a is connected to a signal feeding end 41a of the antenna element 4a, while the other end of the antenna signal feeding line 51a is connected to the antenna signal feeding line connecting end 321a of the antenna transceiving module 32a. On the other hand, one end of the ground connecting line 52a is connected to a ground connecting end 42a of the antenna element 4a, while the other end of the ground connecting line 52a is connected to the anti-EMI plate ground 131a of the anti-EMI plate 13a.

The wireless signal received by the antenna element 4a is conducted to the antenna transceiving module 32a through the antenna signal feeding line 51a, and the wireless signal is processed by the antenna transceiving module 32a and is transferred to the electronic device 100a. On the contrary, data-to-be-transmitted are conducted to the antenna transceiving module 32a and processed by the antenna transceiving module 32a. The data is then transmitted by the antenna element 4a through the conducting of the antenna signal feeding line 51a.

Besides, the antenna element 4a is coupled to the anti-EMI plate ground 131a of the anti-EMI plate 13a through the ground connecting line 52a. Since the antenna element 4a is coupled to a ground with a larger area, the enhancement of the stability of the transceiving of the wireless signal of the antenna element and the ability of the antenna element to prevent interferences is predictable.

In addition, the distance from the antenna element 4a to the ground is effectively shortened through the connection of the antenna element 4a to the anti-EMI plate ground 131a of the anti-EMI plate 13 by the ground connecting line 52a. As a consequence, the ability of the antenna element 4a to tolerate interferences and the speed of the antenna element 4a to exclude noises are enhanced.

In the preferred embodiment of the present invention, the electronic device 100a is a portable personal computer (i.e. a notebook), and the anti-EMI plate 13a, which is generally made of aluminum or tin foil, is a plate with the ability to prevent electromagnetic interferences. The utilization of any other element with the same/similar function as the anti-EMI plate 13a, however, is to be adapted in accordance with different fields of application.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. An antenna device arranged inside a display module of an electronic device, the display module being provided with an anti-EMI plate, comprising:
an antenna element with a ground connecting end and a signal feeding end for transceiving a wireless signal;
a ground connecting line coupled to the ground connecting end of the antenna element and the anti-EMI plate; and
an antenna signal feeding line coupled to the signal feeding end of the antenna element for feeding the wireless signal transceived by the antenna element.

2. The antenna device as claimed in claim 1, wherein the anti-EMI plate is a thin plate made by electro-conductive materials and arranged on an inner surface of the electronic device.

3. The antenna device as claimed in claim 1, wherein the display module is mounted on the electronic device via a pivot mechanism so that the display module is rotatably operable around the pivot mechanism.

4. The antenna device as claimed in claim 1, wherein the antenna element is a dipole antenna.
